(19) United States
(12) Patent Application Publication
(10) Pub. No.: US 2022/0076278 A1
(43) Pub. Date: Mar. 10, 2022

(54) Publishing of Short Novels or Books

(71) Applicant: Athelda R. Ensley, Brunswick, MD (US)

(72) Inventor: Athelda R. Ensley, Brunswick, MD (US)

(21) Appl. No.: 16/912,301

(22) Filed: Sep. 4, 2020

(51) Int. Cl. G06Q 30/02; G06Q 10/10; G06Q 20/12

(52) U.S. Cl. CPC G06Q 30/02; G06Q 20/123; G06Q 10/10

(57) ABSTRACT

The Publishing of Short Novels or Books Patent will provide authors/writers with an opportunity to publish a few chapters or a portion of their novels or books. The published portion (i.e. 1^{st} Three Chapters) will then be marketed as a book/literary version of a movie trailer product. This published work will exist in written or physical form, as well as, in electronic versions of these novels or books.

### SPECIFICATION TERMS DEFINED

1—Publishing of Short Novels or Books—The actual process of publishing shortened versions of partially or fully completed novels or books is an original activity to achieve printed versions of writer and author works.

2—Few Chapters or a Portion—The pre-selected portion of a novel or book being published, whether the first chapters or another segment, of these works.

3—Marketed—Upon completion of these short novels or books, these works will be marketed for branding and sales purposes benefitting authors, writers, companies, and any other relevant parties.

4—Book/Literary Version of a Movie Trailer Product—The Publishing of Short Novels or Books process and finished product is compared to that of a movie trailer, in that it provides a sneak peek to a completed literary work.

5—Written or Physical Form—The printed and published format produced after completion of the publication process.

6—Electronic Versions—These shorten literary works may be published and available in electronic versions/formats (i.e. e-Books).

7—Public Use—The completed short novels or books may be available for purchase, marketing, etc.

8—Traditional and Technological Processes—The publishing processes used may include the utilization of printing presses/companies, as well as, technology-based remote publication services.

9—Publishing Norms—Publishing of Short Novels or Books is an innovative publishing approach in that the entire work is not the finished product, but a shortened version.

10—Diverse Authors/Writers—This process is available to those who have never had works published or to those who have before.

1. The Publishing of Short Novels or Books Patent will provide authors/writers with an opportunity to publish a few chapters or a portion of their novels or books. The published portion (i.e. 1^{st} Three Chapters) will then be marketed as a book/literary version of a movie trailer product. This published work will exist in written or physical form, as well as, in electronic versions of these novels or books.
This process may be used to publish works by individuals, companies, and others having completed portions for publication purposes. Publishing of Short Novels or Books, which Athelda R. Ensley regards as her invention defines this process as:
1—Using publication processes to provide authors/writers with physical and/or electronic versions of their works (i.e. novels or books), which as of yet have not been published or available for marketing or public use.
2—Publishing by use of traditional and technological processes, shortened portions of authors/writers novels or books for marketing and sales opportunities of these literary works.
3—Innovating current publishing norms and expanding the chances of diverse authors/writers to see their works in print and physical form.
